(19) United States
(12) Patent Application Publication
(10) Pub. No.: US 2007/0234261 A1
(43) Pub. Date: Oct. 4, 2007

(54) Design support device for semiconductor device, design support method for semiconductor device, and design support program for semiconductor device

(75) Inventor: Koichi Nakagawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/455,170

(22) Filed: Jun. 19, 2006

(30) Foreign Application Priority Data
Mar. 30, 2006 (JP) 2006-093348

(51) Int. Cl. G06F 17/50

(52) U.S. Cl. 716/11; 716/13

(57) ABSTRACT

The present invention provides a design support device for a semiconductor device, etc. which can significantly reduce processing steps required in constructing power source wiring patterns and can perform processing at a high speed using a small amount of resources by making conventional bump cells include global power source wiring of meshed configuration. The design support device includes a wiring block acquisition unit that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device, and a power source wiring unit that forms predetermined power source wiring layers of a plurality of layers of the semiconductor device using data by combining wiring blocks acquired by the wiring block acquisition unit.

### BACKGROUND OF THE INVENTION

1. Field of the Invention

The present invention relates to a design support device for a semiconductor device, a design support method for a semiconductor device, and a design support program for a semiconductor device, and more particularly, to a design support device for a semiconductor device, a design support method for a semiconductor device, and a design support program for a semiconductor device which configures a global power source wiring layer of a semiconductor device by appropriately combining and arranging a plurality of blocks each having arranged therein bumps, vias, wires, etc.

2. Description of the Related Art

As shown in FIG. 6, in general, an LSI for processor is divided into several subchips 5a, and is designed for each subchip. An element that is obtained by further dividing the subchip 5a into a plurality of chips is referred to as an LSG. The uppermost-order chip including the subchips 5a each including the LSG is referred to as a chip 5.

In the following explanation, for the sake of convenience, it is assumed that a single LSG is included in the subchip, and a two-tier structure configured by the chip and subchip will be explained. Power source wiring of a processor LSI is roughly classified into a global power source wiring layer that is configured by a mesh, and a local power source wiring layer that is connected to respective cells.

The global power source wiring layer is configured under the chip level, while the local power source wiring layer is configured under the subchip level. As layers for power source wiring, in case of a product having ten layers, four layers which include the uppermost layer and the following layers configure a global power source wiring layer (chip level) 7, while other layers which include the lowermost layer configure a local power source wiring layer (subchip level) 8, as shown in FIG. 7.

FIG. 8 shows a design flow for LSI. As shown, in the chip level, a layoutDB is formed from a Verilog (step S1), a floor plan is formed (step S2), bump arrangement (step S3), power source wiring (step S4), clock wiring (step S5) are performed, and lower hierarchical wiring is settled (step S6).

On the other hand, in the subchip level, a layoutDB is formed from a Verilog (step S7), a floor plan is formed (step S8), cells are arranged (step S9), and upper wiring is taken in the subchip level (step S10) due to above-described lower hierarchical wiring settling in the chip level (step S6).

Then, power source wiring (step S11), clock wiring (step S12), general wiring (step S13), error check (step S14), library processing (step S15) are performed, a layoutDB is formed from a Verilog and a lower hierarchical library (step S16), error check (step S17), and releasing (step S18) are performed.

As shown in FIG. 9, in which outline of power source wiring is represented, power source wiring of the chip level (tenth layer to seventh layer) employs the meshed configuration so as to supply stable power to the entire chip surface. The connection point of a processor and a package is referred to as a bump, the terminal of a bump cell is set to a point to supply power, and wires and vias of the tenth layer to seventh layer are connected to form the meshed configuration.

In power source wiring of the subchip level, power source wiring pattern of the seventh layer of the chip level is set to the connection point, wiring up to the power source terminal of the first layer of a cell under a predetermined rule.

As the kinds of the bump cell, there are VDD, VDD2, VDD3, VSS, SIG, DUMMY, etc., and the uppermost layer has a terminal to be connected to bumps. Terminals of the respective bump cells and power source patterns are different depending on the kind.

Of regions of one bump cell, regions of surrounding ten and several grids are regions through which wires of clock and clock shield pass. Power source wiring patterns of the regions have to have their patterns changed depending on kinds of neighboring bump cells.

FIG. 10 shows processing steps from arrangement of bump cells to wiring of clock. As shown in FIG. 10, after bump cells are arranged (FIG. 10A), power source wiring processing is performed (FIG. 10B), and then clock wiring processing is performed (FIG. 10C).

In the bump cell arrangement processing (FIG. 10A), bump cells are arranged on the surface layer of the global power source layer, and in the power source wiring processing (FIG. 10B), a global power source wiring layer is constructed by appropriately arranging wiring parts such as vias and wires one-by-one between bumps and a local power source wiring layer. As a reference technique, there is known a Patent Document 1: (Jpn. Pat. Appln. Laid-Open Publication No. 6-97369).

However, the conventional chip level power source wiring method has the following problems. As described above, after arranging bump cells, a global power source wiring layer is constructed by appropriately arranging wiring parts such as vias and wires one by one between bumps and a local power source wiring layer. Therefore, in a program for carrying out power source wiring processing, and in a program for dealing with power source wiring, the number of wires and vias configuring a mesh becomes significantly large, which consumes a large amount of machine resources. Furthermore, processing time is increased.

Furthermore, in an interactive application, since the number of patterns to be displayed becomes large, the response speed is lowered, which requires much time.

Furthermore, it becomes difficult to check whether or not correct patterns are generated for bumps.

### SUMMARY OF THE INVENTION

It is therefore an object of the present invention to overcome the above-mentioned drawbacks by providing a design support device for a semiconductor device, a design support method for a semiconductor device, and a design support program for a semiconductor device which can significantly reduce processing steps required in constructing power source wiring patterns and can perform processing at a high speed using a small amount of resources by making conventional bump cells include global power source wiring of meshed configuration.

According to the present invention, there is provided a design support device for a semiconductor device that designs a semiconductor device using a computer, including: a wiring block acquisition unit that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and a power source wiring unit that forms predetermined power source wiring layers of a plurality of layers of the semiconductor device using data by combining wiring blocks acquired by the wiring block acquisition unit.

According to the design support device for a semiconductor device, the device further includes: a connection block acquisition unit that acquires predetermined connection blocks as data from a plurality of connection blocks whose connection pattern structures are different from each other, the connection blocks being used to connect a plurality of wiring blocks, and the power source wiring unit forms power source wiring layers by connecting a plurality of wiring blocks using connection blocks acquired by the connection block acquisition unit.

According to the design support device for a semiconductor device, the wiring blocks have bumps formed on the surface thereof, and configure power source wiring layers of a global layer formed on a local layer forming a plurality of subchips.

According to the design support device for a semiconductor device, the wiring block acquisition unit acquires wiring blocks from a storage unit based on a user designation, and forms power source wiring layers.

According to the design support device for a semiconductor device, the connection block acquisition unit selects and acquires predetermined connection blocks from the storage unit based on the combination of the wiring blocks.

According to the design support device for a semiconductor device, power source wiring patterns configured by the wiring blocks include ground wiring patterns and VDD power source patterns.

According to the present invention, there is also provided a design support method for a semiconductor device that designs a semiconductor device using a computer, including: a wiring block acquisition step that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and a power source wiring step that forms predetermined power source wiring layers of a plurality of layers of the semiconductor device using data by combining wiring blocks acquired by the wiring block acquisition step.

According to the design support method for a semiconductor device, the method further includes: a connection block acquisition step that acquires predetermined connection blocks as data from a plurality of connection blocks whose connection pattern structures are different from each other, the connection blocks being used to connect a plurality of wiring blocks, and the power source wiring step forms power source wiring layers by connecting a plurality of wiring blocks using connection blocks acquired by the connection block acquisition step.

According to the present invention, there is also provided a design support program for a semiconductor device that designs a semiconductor device using a computer, the program making a computer execute the steps including: a wiring block acquisition step that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and a power source wiring step that forms predetermined power source wiring layers of a plurality of layers of the semiconductor device using data by combining wiring blocks acquired by the wiring block acquisition step.

According to the present invention, processing steps which are conventionally required in constructing power source wiring patterns can be significantly reduced, and power source wiring patterns can be constructed at a high speed using a small amount of resources.

### BRIEF DESCRIPTION OF THE DRAWINGS

FIG. 1 shows a block diagram of the embodiment according to the present invention;

FIG. 2 shows a flowchart indicative of the performance of the embodiment according to the present invention;

FIG. 3 shows a side view of a global power source wiring layer of the embodiment according to the present invention;

FIG. 4 shows a plan view of the global power source wiring layer of FIG. 3;

FIG. 5 shows processing steps in constructing power source wiring layers of the embodiment according to the present invention;

FIG. 6 shows a plan view of an LSI for processor;

FIG. 7 shows the hierarchy of power source wiring;

FIG. 8 shows a flowchart indicative of layout design for a semiconductor device;

FIG. 9 shows the outline of power source wiring of a semiconductor device; and

FIG. 10 shows conventional processing steps in constructing power source wiring layers.

### DETAILED DESCRIPTION OF THE PREFERRED EMBODIMENTS

The embodiments of the present invention will further be described below with reference to the accompanying drawings.

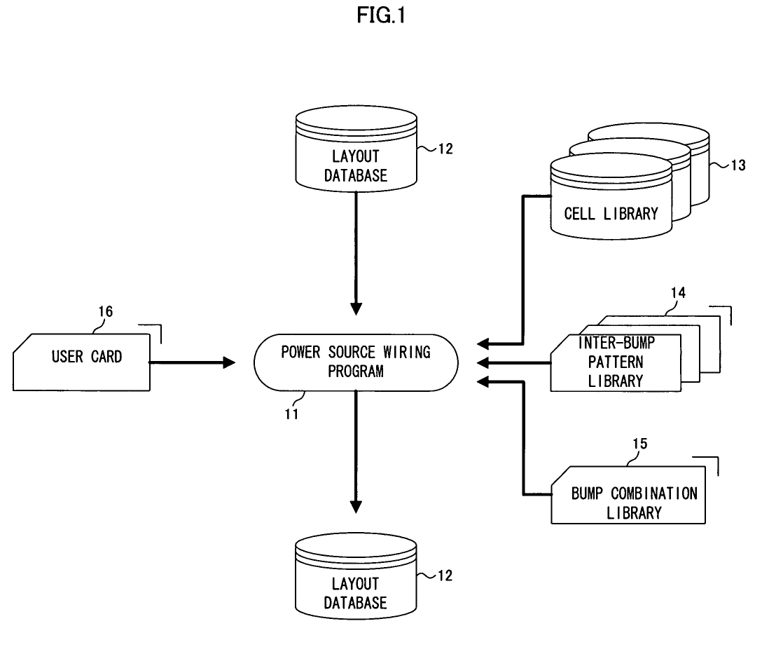

FIG. 1 shows a block diagram of a design support device for a semiconductor device according to the present invention.

As shown in FIG. 1, the design support device includes, as hardware requirements for a power source wiring program 11 to be executed by a CPU, layout databases 12, cell libraries 13, inter-bump (wiring block) pattern (connection block) libraries 14, bump (wiring block) combination libraries 15.

In executing the power source wiring program 11, a user (designer) sends a designation using a user card 16. It becomes possible to construct power source wiring patterns by specifying arrangement regions and 10 regions of particular cells (bump cells to be described later) in the user card 16.

Being mixed with libraries of general cells, the cell libraries 13 include libraries of bump cells being wiring blocks of the present invention. The bump cell has bumps formed on the surface thereof, and includes a power source pattern composed of vias and wires formed in the inside thereof.

The inter-bump pattern library has written therein power source wiring patterns among bump cells in the form of text. The power source wiring patterns among bump cells are required for respective combinations of kinds of neighboring bump cells. The bump combination library defines, for combinations of bump cells, the relation of the combinations and the inter-bump pattern library.

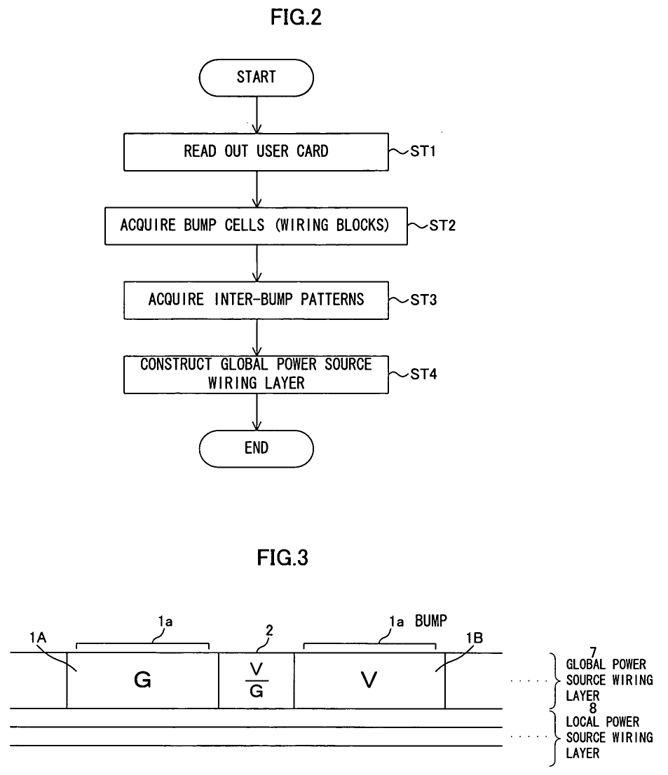

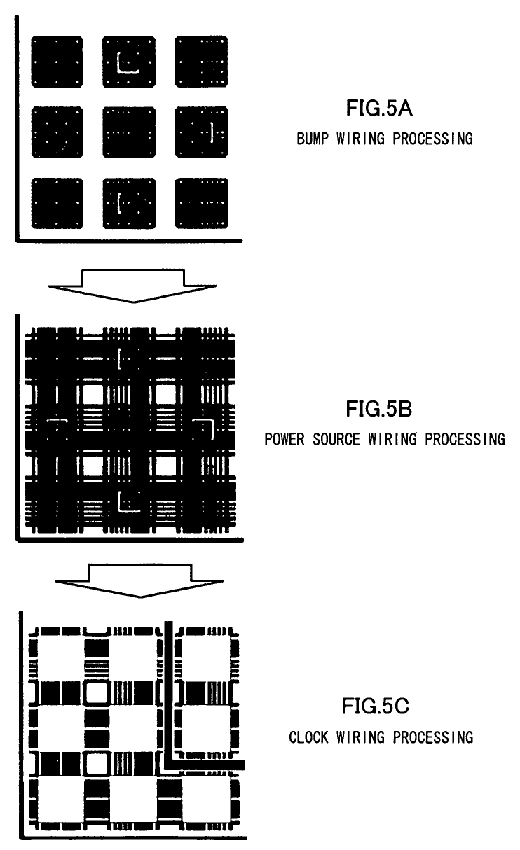

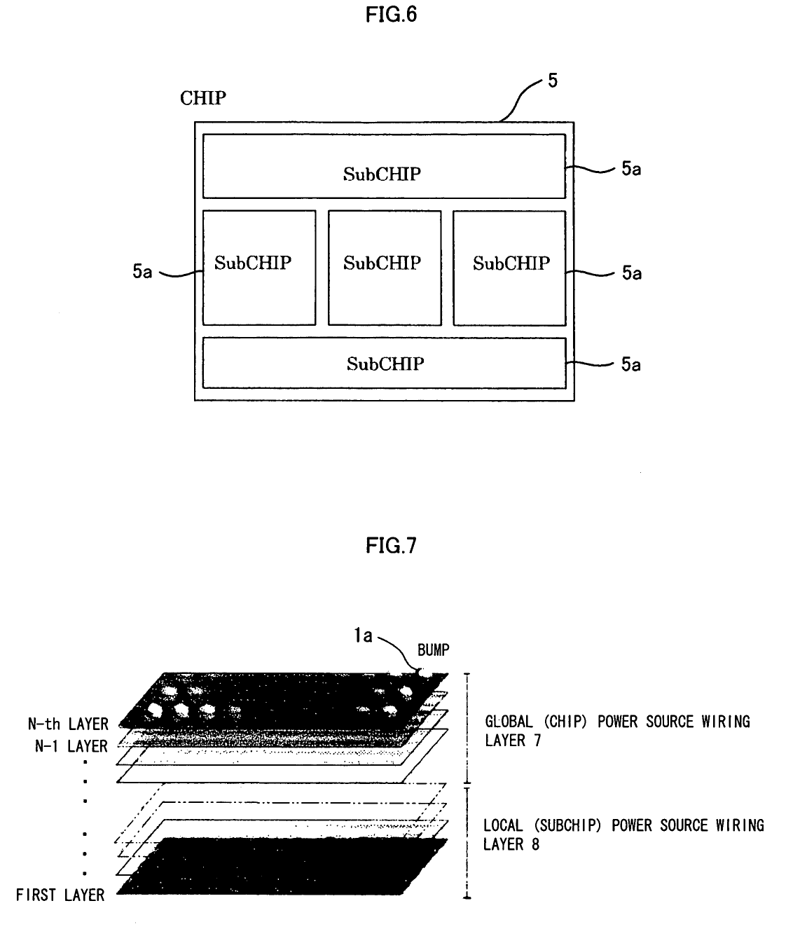

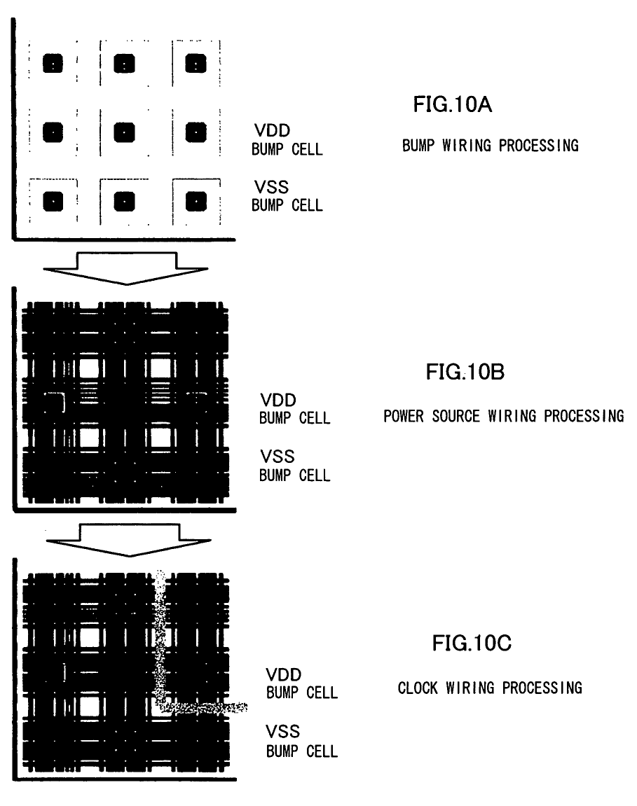

Next, the performance of the embodiment will be explained using a flowchart shown in FIG. 2. FIG. 5 shows processing steps of the embodiment, being contrasted with those shown in FIG. 10.

Firstly, the user card is read out to acquire arrangement region information and IO region information of bumps (step ST1), and, based on the information, bump cells (wiring blocks) satisfying the specification condition by the user card are acquired from the cell library by means of the bump combination library (step ST2). Then, inter-bump patterns (connection blocks) connecting the bump cells (wiring blocks) for combinations of the bump cells (wiring blocks) are acquired from the inter-bump pattern library (step ST3).

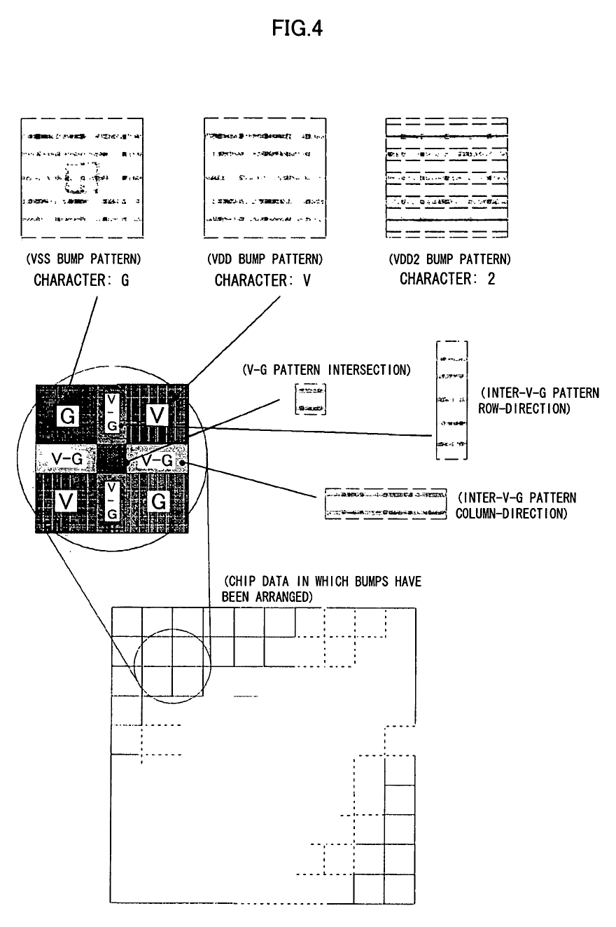

Then, thus acquired wiring blocks are so combined as to satisfy a layout (FIG. 5A), and are connected using connection blocks (FIG. 5B), thereby constructing a global power source wiring layer shown in FIG. 3 and FIG. 4 (step ST4). Then, clock wiring processing shown in FIG. 5C is performed to complete the construction of the power source wiring layer of a global layer.

In above-described configuration, being executed by a CPU, the bump combination library configures a wiring block acquisition unit (step ST2), a power source wiring unit (step ST4), and a connection block acquisition unit (step ST3) of the present invention.

FIG. 3 shows a side view of the global power source wiring layer, and FIG. 4 shows a plan view of the same. Alphabet characters “G” and “V” are allocated to a bump cell kind of 1A and a bump cell kind of 1B respectively, and pattern file names are defined for the cases of column-direction neighboring, row-direction neighboring, and diagonal-direction neighboring, respectively. Between bump cells (wiring blocks) 1A and 1B on which a bump 1a is formed, an inter-bump pattern (connection block) 2 is formed.

Next, the steps of providing above-described bump cell library (wiring block) and program library will be explained.

1) The power source wiring width and wiring spacing are calculated for respective layers from processor requirements (operating frequency, power consumption, chip size, etc.)

2) Patterns are allocated to bump cells to form a GDS.

3) Whether or not there is a short circuit or a spacing error is checked.

4) A file that is formed in 2) is provided as a bump cell library (wiring layer block).

5) Confirming arrangement requirements of bump cells and arrangement requirements of particular cells, combinations of kinds of neighboring bump cells are calculated to form a bump combination library.

6) An inter-bump pattern is formed.

7) Test data is formed to check whether or not there is raised an error in an intra-bump-cell pattern and in an inter-bump-cell pattern.

8) A file that is formed in 6) is provided as an inter-bump pattern library.

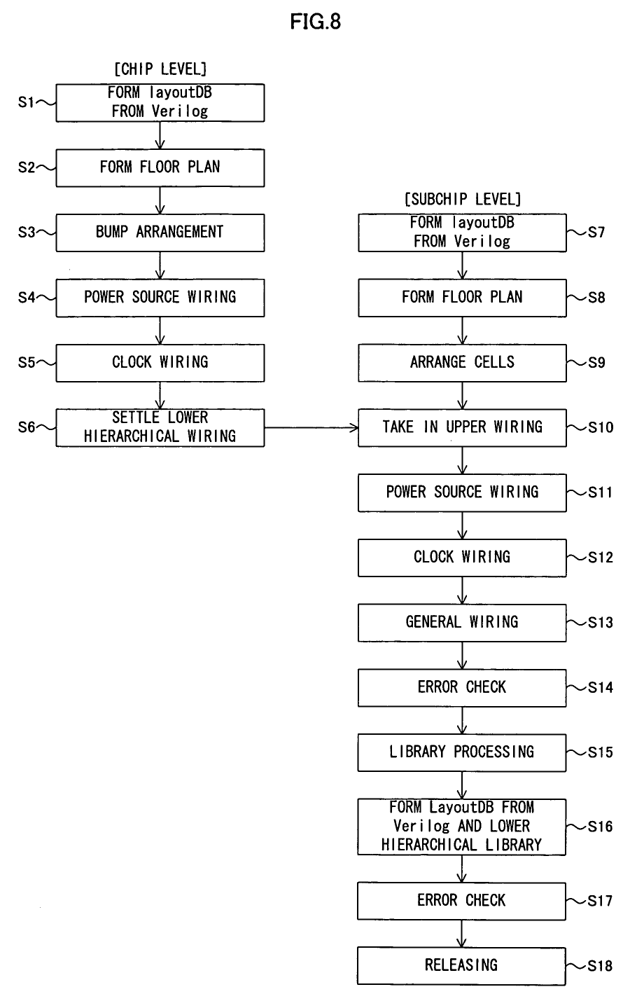

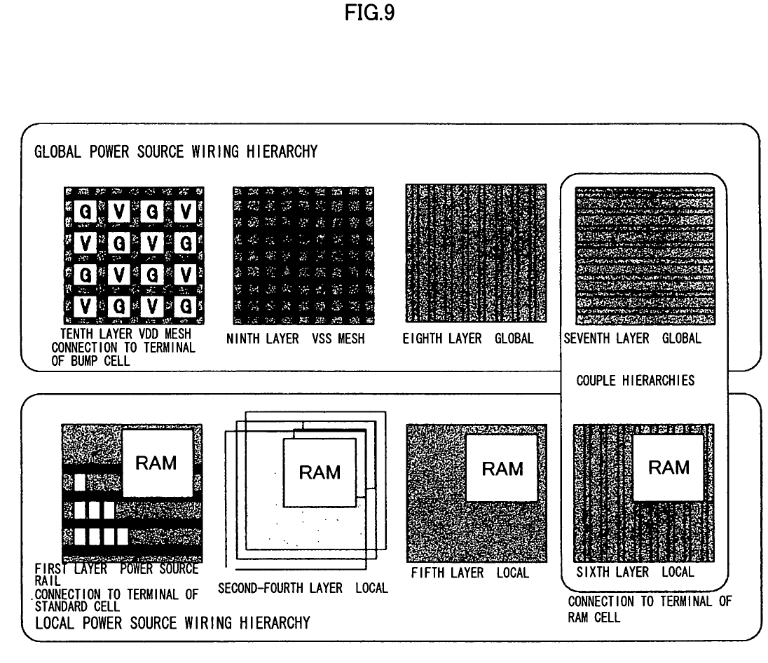

According to the embodiment, the bump arrangement processing (step S3) and power source wiring processing (step S4) in the flowchart shown in FIG. 8 are carried out at the same time, which can significantly reduce the processing steps.

According to the embodiment of the present invention, due to the effect of reducing the number of wiring patterns, processing can be performed at a high speed using a small amount of machine resources. For example, as one example, 60 percent of objects are reduced in the number of wires, while 80 percent of objects are reduced in the number of vias. Accordingly, due to the reduction of objects, up to 70 percent of processing time period is reduced. Furthermore, in case a problem is raised in a power source wiring pattern, examination is carried out for each bump cell unit, which can improve maintenance property.

As described above, according to the embodiment of the present invention, since a global wiring layer is constructed by building in and arranging conventional bump cells and power source patterns in a wiring block, and arranging a connection block composed of wires and vias in the form of a library between wiring blocks, the construction processing for the global power source wiring layer can be performed rapidly using a small amount of resources. Furthermore, since the wiring layer is configured in the form of blocks, the configuration is simplified, and it can be easily assured that there is no error in wiring patterns. After performing clock wiring on thus constructed global power source wiring layer, by extracting the pattern, and settling the wiring pattern to the lower hierarchy, designing a semiconductor device can be performed rapidly using a small amount of resources.

In the embodiment of the present invention, the design support method for a semiconductor device can be executed by a computer by storing the steps shown in the flowchart in a computer-readable recording medium as the design support program for a semiconductor device. In the present invention, the computer-readable recording medium may be a portable recording medium such as a CD-ROM, flexible disk, DVD disk, magnet-optical disk, IC card, or a database storing computer programs, or other computers and their databases, or a transmission medium on a line.

What is claimed is:

1. A design support device for a semiconductor device that designs a semiconductor device using a computer, comprising:
a wiring block acquisition unit that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and
a power source wiring unit that forms predetermined power source wiring layers of a plurality of layers of the semiconductor device using data by combining wiring blocks acquired by the wiring block acquisition unit.

2. The design support device for a semiconductor device according to claim 1, further comprising:
a connection block acquisition unit that acquires predetermined connection blocks as data from a plurality of connection blocks whose connection pattern structures are different from each other, the connection blocks being used to connect a plurality of wiring blocks,
wherein the power source wiring unit forms power source wiring layers by connecting a plurality of wiring blocks using connection blocks acquired by the connection block acquisition unit.

3. The design support device for a semiconductor device according to claim 1, wherein
the wiring blocks have bumps formed on the surface thereof, and configure power source wiring layers of a global layer formed on a local layer forming a plurality of subchips.

4. The design support device for a semiconductor device according to claim 1, wherein
the wiring block acquisition unit acquires wiring blocks from a storage unit based on a user designation, and forms power source wiring layers.

5. The design support device for a semiconductor device according to claim 1, wherein
the connection block acquisition unit selects and acquires predetermined connection blocks from the storage unit based on the combination of the wiring blocks.

6. The design support device for a semiconductor device according to claim 1, wherein
power source wiring patterns configured by the wiring blocks include ground wiring patterns and VDD power source patterns.

7. A design support method for a semiconductor device that designs a semiconductor device using a computer, comprising:
a wiring block acquisition step that acquires predetermined wiring blocks as data from a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and
a power source wiring step that forms predetermined power source wiring layers of a plurality of layers of the semiconductor device using data by combining wiring blocks acquired by the wiring block acquisition step.

8. The design support method for a semiconductor device according to claim 7, further comprising:
a connection block acquisition step that acquires predetermined connection blocks as data from a plurality of connection blocks whose connection pattern structures are different from each other, the connection blocks being used to connect a plurality of wiring blocks,
wherein the power source wiring step forms power source wiring layers by connecting a plurality of wiring blocks using connection blocks acquired by the connection block acquisition step.

9. The design support method for a semiconductor device according to claim 7, wherein
the wiring blocks have bumps formed on the surface thereof, and configure power source wiring layers of a global layer formed on a local layer forming a plurality of subchips.

10. The design support method for a semiconductor device according to claim 7, wherein
the wiring block acquisition step acquires wiring blocks from a storage unit based on a user designation, and forms power source wiring layers.

11. The design support method for a semiconductor device according to claim 7, wherein
the connection block acquisition step selects and acquires predetermined connection blocks from the storage unit based on the combination of the wiring blocks.

12. A design support program for a semiconductor device that designs a semiconductor device using a computer, the program making a computer execute the steps comprising:
a wiring block acquisition step that acquires predetermined wiring blocks as data from among a plurality of wiring blocks whose wiring pattern structures formed in the insides of the respective wiring blocks in the layer thickness direction thereof are different from each other, the plural wiring blocks being used to form power source wiring layers of a plurality of layers of the semiconductor device; and
a power source wiring step that forms predetermined power source wiring layers of a plurality of layers of the semiconductor device using data by combining wiring blocks acquired by the wiring block acquisition step.

13. The design support program for a semiconductor device according to claim 12, further comprising:
a connection block acquisition step that acquires predetermined connection blocks as data from a plurality of connection blocks whose connection pattern structures are different from each other, the connection blocks being used to connect a plurality of wiring blocks;
wherein the power source wiring step forms power source wiring layers by connecting a plurality of wiring blocks using connection blocks acquired by the connection block acquisition step.

14. The design support program for a semiconductor device according to claim 12, wherein
the wiring blocks have bumps formed on the surface thereof, and configure power source wiring layers of a global layer formed on a local layer forming a plurality of subchips.

15. The design support program for a semiconductor device according to claim 12, wherein
the wiring block acquisition step acquires wiring blocks from a storage unit based on a user designation, and forms power source wiring layers.

16. The design support program for a semiconductor device according to claim 12, wherein
the connection block acquisition step selects and acquires predetermined connection blocks from the storage unit based on the combination of the wiring blocks.
